(19) United States
(12) Patent Application Publication
(10) Pub. No.: US 2012/0320027 A1
(43) Pub. Date: Dec. 20, 2012

(54) LIQUID CRYSTAL DISPLAY DEVICE

(75) Inventor: Kohji Ueno, Osaka-shi (JP)

(73) Assignee: SHARP KABUSHIKI KAISHA, Osaka-shi, Osaka (JP)

(21) Appl. No.: 13/581,613

(22) PCT Filed: Feb. 24, 2011
(86) PCT No.: PCT/JP2011/054146

§ 371 Date: Aug. 29, 2012

(30) Foreign Application Priority Data
Mar. 1, 2010 (JP) 2010-044296

(51) Int. Cl. G09G 5/00; G09G 3/36

(52) U.S. Cl. 345/212; 345/87

(57) ABSTRACT

Disclosed is a liquid crystal display device that can convert a bright spot easily into a black spot. The liquid crystal display device is provided with; a drive circuit board on which an IC chip (4) is mounted, a counter substrate arranged opposite to the drive circuit board, and a liquid crystal layer sandwiched between the drive circuit board and the counter substrate; an external circuit board (6) on which a stabilizing capacitor element (7) for generating a power supply voltage in the IC chip (4) is mounted; and a connection wiring board (5) for connecting the drive circuit board and the external circuit board (6), wherein an auxiliary capacitor wiring (3) and a power supply voltage terminal (14) are connected directly to each other on the circuit board.

### TECHNICAL FIELD

The present invention relates to a liquid crystal display device provided with a liquid crystal panel where an IC chip formed with a drive circuit is mounted on a drive circuit board. The present invention in particular relates to a liquid crystal display device provided with a liquid crystal panel having a function of converting a bright spot into a black spot.

### BACKGROUND ART

As thin and power-saving display terminals, liquid crystal display devices provided with liquid crystal panels go mainstream of video display terminals, e.g., television sets and monitors of personal computers. Further, making the most of its reduced thickness and reduced weight, the liquid crystal display devices are used widely as display terminals for car navigation and personal digital assistant (PDA), mobile equipment such as portable phones and portable game players, and portable equipment.

In a typical liquid crystal panel, a predetermined potential difference is provided to a plurality of pixel electrodes arranged for the respective pixels formed on respective substrates arranged oppositely to each other sandwiching a liquid crystal layer and a common electrode arranged commonly to all of the pixels, thereby rotating the liquid crystal molecules of the liquid crystal layer with this potential difference. Due to the rotation of the liquid crystal molecules, the polarization direction of the light passing through the liquid crystal panel is changed, and light transmittance at each pixel is changed by combination of polarizing plates arranged on the front and back outer surfaces of the liquid crystal panel, thereby displaying images.

At that time, due to the relation between the voltage to be applied to the liquid crystal layer and the transmittance of the light passing through the liquid crystal panel, two drive modes of the liquid crystal panel exist, specifically, a normally white type where the transmittance is maximized when the liquid crystal layer is not applied with voltage, and a normally black type where light is not transmitted when the liquid crystal layer is not applied with voltage. The normally white type has become the mainstream as the drive mode for a liquid crystal panel, as it has some advantages for example in saving the drive electric power.

There is a problem in a normally white type liquid crystal panel of an active matrix system. Namely, in a case where TFT (Thin Film Transistor) as a switching element for applying voltage to the pixel electrode is destroyed and becomes nonconductive so that the predetermined voltage is not applied to the space between the pixel electrodes and the common electrode, the pixel will not be turned black but displayed as a bright spot even if a signal for black display is inputted as the image signal. When such a bright spot is generated at the time of occurrence of defects in the components of the drive circuit formed in the liquid crystal panel, existence of the defect becomes noticeable for the user, which is not preferable. Therefore, a technique for converting a bright spot into a black spot is used in a case where defects such as destruction of TFT and/or non-conductivity or short circuit of wiring occur, namely, the wiring formed on the substrate for composing the liquid crystal panel is processed with a laser beam so as to make the pixel at the defect not as a bright spot but as a less noticeable black spot.

FIG. 5 shows an example of applying a technique for converting a bright spot into a black spot in a liquid crystal panel of a conventional active matrix system.

As shown in FIG. 5, in a liquid crystal panel 111 of an active matrix system, scanning signals are supplied from a gate driver 113 to scanning lines G101, G102 . . . , and data signals are supplied from a source driver 112 to signal lines S101 . . . . The supplied image signals are applied as a pixel voltage to the pixel electrode 122 via TFT 121 whose ON/OFF is controlled by the scanning signals. The liquid crystal panel 111 displays an image due to the potential difference between the pixel voltage and a voltage Vcom of the opposing common electrode.

In a case of regarding the relations between the voltages of the respective pixels as an equivalent circuit, the gate electrodes of the TFT 121 are connected to the scanning lines G101 . . . ; the source electrodes are connected to the signal lines S101 . . . ; and the drain electrodes are connected to one of electrodes of a pixel capacitor Clc formed by interposing a liquid crystal layer between the pixel electrode 122 and the common electrode, and also to one of electrodes of an auxiliary capacitor Ccs formed between a pixel electrode of each pixel and an auxiliary capacitor wiring formed in the vicinity thereof. Further, the other electrode of the pixel capacitor Clc is connected to a common voltage line 131 that applies a voltage Vcom to the common electrode, and the other electrode of the auxiliary capacitor Ccs is connected to an auxiliary capacitor wiring 132 that applies a voltage Vcs for forming the auxiliary capacitor.

Here, in a case where the liquid crystal panel 111 is a normally white type, when the TFT 121 becomes non-conductive due to destruction, the pixel capacitor Clc is not applied with voltage. As a result, a pixel corresponding to the pixel electrode 122 becomes constantly a bright spot irrespective of the video signal.

For converting this bright spot into a black spot, the wirings that connects the drain electrode of the TFT 121 to the pixel capacitor Clc and to the auxiliary capacitor Ccs is disconnected with a laser beam and the auxiliary capacitor Ccs is short-circuited, thereby providing the pixel capacitor Clc with a potential difference (Vcom−Vcs) between the potential Vcom of the common electrode and the potential Vcs to be connected to the auxiliary capacitor Ccs. Thereby, even when the TFT 121 is destroyed, the pixel capacitor Clc will be applied constantly with voltage, and thus it does not become a bright spot.

And, it is also proposed to connect an auxiliary capacitor electrode line 132 in the auxiliary capacitor Ccs to the source driver power supply circuit 116 so that a voltage closer to the voltage Vsmax of the pixel electrode 122 at the time of turning into a black display at a transmission of 0% to the pixel capacitor Clc, so that the potential Vcs of the auxiliary capacitor Ccs at the side to be connected to the auxiliary capacitor electrode line 132 is made as a source driver power supply voltage (see Patent document 1).

### PRIOR ART DOCUMENTS

### Patent Documents

Patent document 1: JP 2004-117753

### DISCLOSURE OF INVENTION

### Problem to be Solved by the Invention

In a liquid crystal display device for portable use or mobile use utilizing further the advantages of reduced thickness and reduced weight of the liquid crystal panel, a COG (Chip On Glass) technique is used. In this technique, the drive circuit for performing image display on the liquid crystal panel is processed as an IC chip and mounted on a drive circuit board of the liquid crystal panel. And in a liquid crystal display device applied with the COG technique, for corresponding to demand for further minimizing the size and power consumption and further lowering the cost, there is an increased tendency of adding more peripheral circuits within an IC chip to be mounted on the liquid crystal panel.

According to a conventional COG technique, a source driver and a gate driver are formed in an IC chip mounted on a drive circuit board. For example, in a case of a drive circuit that drives a liquid crystal panel 111 as shown in FIG. 5, a COG type liquid crystal panel equipped with an IC chip in which peripheral circuits are formed in addition to a source driver 112 and a gate driver 113 have been used more, particularly for mobiles. Examples of the peripheral circuits include a video data processing circuit (IC controller) 114, a gradient power supply circuit 115, a source driver power supply circuit 116, a gate driver power supply circuit 117, and a common electrode voltage (Vcom) power supply circuit 118.

Therefore, from the viewpoint of further progressing the above-mentioned COG technique for the liquid crystal panel, it is an object of the present invention to provide a liquid crystal display device that enables to convert a bright spot into a black spot easily even in a case where a power supply voltage generating circuit for driving a liquid crystal panel is formed within an IC chip to be mounted on a panel substrate of a liquid crystal panel.

### Means for Solving Problem

For achieving the above-described object, a liquid crystal display device of the present invention is characterized in that it includes: a liquid crystal panel having a drive circuit board on which an IC chip formed with a drive circuit for driving the liquid crystal panel is mounted, a counter substrate arranged opposite to the drive circuit board, and a liquid crystal layer sandwiched between the drive circuit board and the counter substrate; an external circuit board on which a stabilizing capacitor element for generating a power supply voltage in the IC chip is mounted; and a connection wiring board for connecting the drive circuit board and the external circuit board. An auxiliary capacitor wiring for applying an auxiliary capacitor voltage to an auxiliary capacitor arranged in a pixel region of the drive circuit board and a power supply voltage terminal for supplying the power supply voltage of the IC chip are connected directly to each other on the circuit board.

### Effects of the Invention

According to the present invention, a connection between a power supply voltage terminal and an auxiliary capacitor wiring can be provided in a reduced wiring length, bypassing a connected part between substrates, in order to apply a power supply voltage to an auxiliary capacitor for the purpose of converting easily a bright spot into a black spot. Therefore, in a COG panel prepared by forming a power supply voltage generating circuit in an IC chip so as to convert a bright spot into a black spot, degradation in the quality of display images due to occurrence of brightness irregularity or the like in the display image can be prevented effectively.

### BRIEF DESCRIPTION OF DRAWINGS

FIG. 1 is a diagram for showing a schematic configuration of a liquid crystal display device according to an embodiment of the present invention.

FIG. 2 is a diagram for showing a configuration example of a connection terminal of an IC chip mounted on a drive circuit board of a liquid crystal display device according to the present invention.

FIG. 3 is a diagram for showing an example of relations between voltages with regard to image display of a liquid crystal display device according to an embodiment of the present invention.

FIG. 4 is a diagram for showing another example of a schematic configuration of a liquid crystal display device according to an embodiment of the present invention.

FIG. 5 is a diagram for explaining the principle that a bright spot is converted into a black spot in a conventional liquid crystal display device.

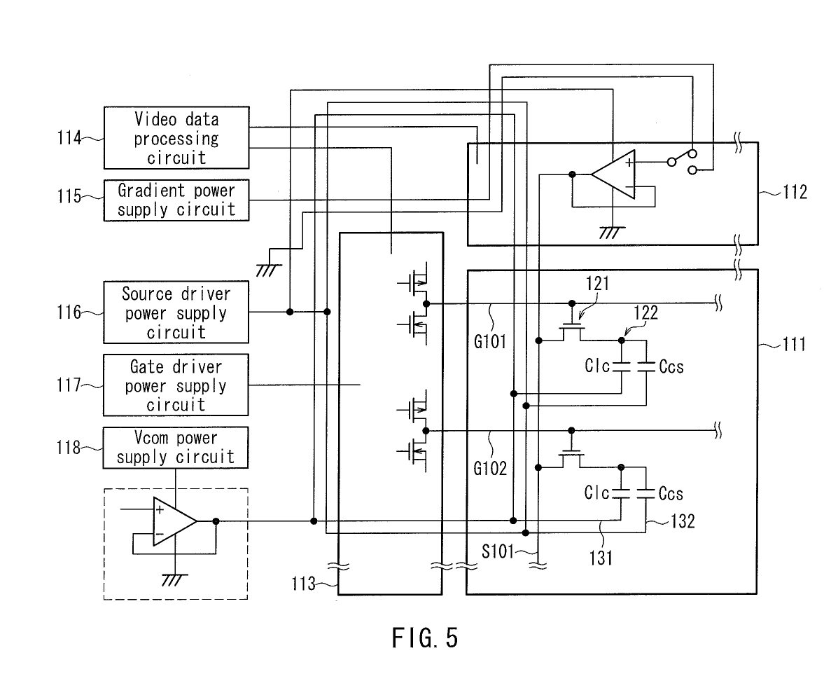

### DESCRIPTION OF THE INVENTION

A liquid crystal display device according to the present invention is a liquid crystal display device including: a liquid crystal panel having a drive circuit board on which an IC chip formed with a drive circuit for driving the liquid crystal panel is mounted, a counter substrate arranged opposite to the drive circuit board, and a liquid crystal layer sandwiched between the drive circuit board and the counter substrate; an external circuit board on which a stabilizing capacitor element for generating a power supply voltage in the IC chip is mounted; and a connection wiring board for connecting the drive circuit board and the external circuit board. An auxiliary capacitor wiring for applying an auxiliary capacitor voltage to an auxiliary capacitor arranged in a pixel region of the drive circuit board and a power supply voltage terminal for supplying the power supply voltage of the IC chip are connected directly to each other on the circuit board.

Accordingly, a connection between a power supply voltage terminal and an auxiliary capacitor wiring can be performed in a drive circuit board of a liquid crystal panel, bypassing an external circuit board and/or a connection wiring board. Such a connection is provided to apply a power supply voltage to an auxiliary capacitor in a COG panel having an IC chip in which a power supply voltage generating circuit is formed. And the power supply voltage is generated in the IC chip in order to convert a bright spot easily into a black spot. Accordingly, the connection between the power supply voltage terminal and the auxiliary capacitor wiring can be provided in a reduced wiring length, bypassing the connected part between the drive circuit board and the connection wiring board and the connected part between the external circuit board and the auxiliary capacitor wiring, and thus it is possible to exclude influences of load fluctuation or the like accompanying the increase in the connection impedance. As a result, it is possible to prevent effectively degradation in the quality of display image, such a degradation is caused by brightness irregularity or the like on the display image due to the load fluctuation of the source driver power supply.

In the above-mentioned liquid crystal display device of the present invention, it is preferable that the connection between the power supply voltage terminal formed at an input terminal side of the IC chip and the auxiliary capacitor wiring is provided via a dummy terminal formed at an output terminal side of the IC chip. Accordingly, since the stabilizing capacitor element is formed on the external circuit board, it is possible to connect the power supply voltage terminal formed at the input terminal side and the auxiliary capacitor wiring formed at a pixel located at the output terminal side in a reduced wiring length.

Further it is preferable that the stabilizing capacitor element of the external circuit board and the auxiliary capacitor wiring are connected to each other via an auxiliary connection wiring formed on the external circuit board and on the connection circuit board. Accordingly, the auxiliary capacitor wiring and the power supply voltage terminal of the IC chip can be connected to each other not only through a direct connection on the drive circuit board but also through a connection via the wiring of the external circuit board and the wiring of the connection wiring board. And thus, the connection impedance can be reduced further so as to prevent degradation in the quality of the display image.

Furthermore, the power supply voltage generated in the IC chip can be provided as a source driver power supply voltage that drives the liquid crystal panel.

### Embodiment

Hereinafter, an embodiment of the present invention will be described with reference to attached drawings.

It should be noted that, for convenience, only the main components required for describing the invention disclosed herein are shown among the constituent components in the drawings referenced hereinbelow. Therefore, the display device disclosed herein may include optional constituent components not shown in the referenced drawings. In addition, the dimensions of the components in the drawings do not always faithfully represent the size of the actual constituent components and the dimensional proportions etc. of the components.

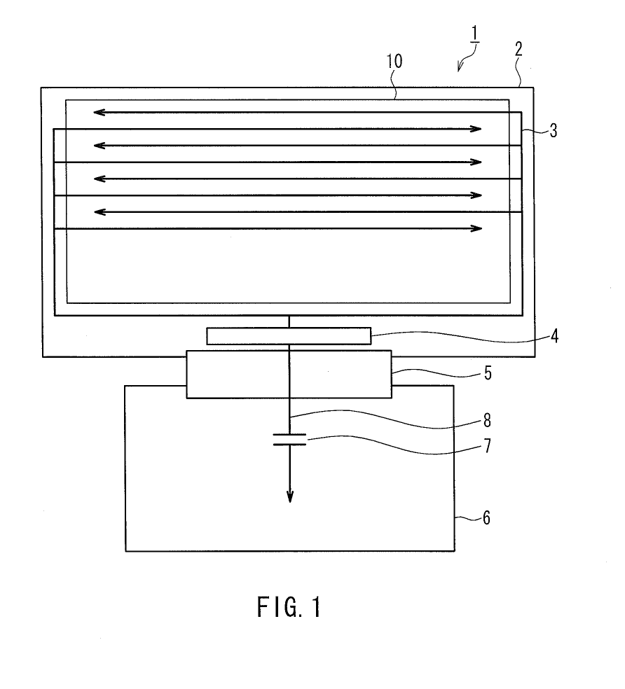

FIG. 1 is a diagram for showing a schematic configuration of a liquid crystal display device according to an embodiment of the present invention.

A liquid crystal display device 1 of the present embodiment has a liquid crystal panel 2, an external circuit board 6, and a connection wiring board 5 that connects the liquid crystal panel 2 and the external circuit board 6.

The liquid crystal panel 2 is formed of a drive circuit board made of glass and a counter substrate similarly made of glass, which are arranged with a predetermined space therebetween, and a liquid crystal layer (not shown) is sandwiched by the drive circuit board and the counter substrate.

In FIG. 1, in the liquid crystal panel 2, only an auxiliary capacitor wiring 3 arranged in the scanning line direction as the transverse direction in FIG. 1 is indicated in a pixel region 10 on which a plurality of pixels have been formed. In the example as shown in FIG. 1, this auxiliary capacitor wiring 3 is arranged in a state separated by an insulating layer from a plurality of pixel electrodes (not shown) formed in matrix on the pixel region 10, and the auxiliary capacitor wiring 3 forms an auxiliary capacitor Ccs for each pixel between the pixel electrodes. It should be noted that the auxiliary capacitor wiring as shown in FIG. 1 is just an example, and it is not limited to the wiring system to be wired alternately in both transverse directions as shown in FIG. 1.

Though not shown in the drawing, as mentioned above, a plurality of pixel electrodes are arranged in matrix of rows and columns on the inner surface of the drive circuit board as one of the two substrates that compose the liquid crystal panel 2. Further, a common electrode is formed on the inner surface of the counter substrate as the other substrate of the two substrates composing the liquid crystal panel. Therefore, the oriented state of the liquid crystal particles of the liquid crystal layer is changed by adjusting the potentials between the pixel electrodes and the common electrode, so that characters and images are displayed.

In the liquid crystal display panel 2 of the liquid crystal display device 1 according to the present embodiment, a plurality of scanning lines arranged on the pixel region 10 of the drive circuit board in the row direction of the pixel electrodes, a plurality of signal lines arranged in the column direction, and TFTs are formed. The TFTs are switching elements each arranged in the vicinity of an intersection of the scanning line and the signal line crossing each other, and connected to each of the pixel electrodes. And, by applying sequentially a scanning voltage to the scanning lines, the TFT as a switching element is turned ON and selected for each row, and furthermore, a pixel voltage necessary for image display is applied via the signal lines to each pixel electrode belonging to the selected row.

On the inner surface of the counter substrate as one of the substrates, color filters corresponding to the respective pixels are formed for a color image display, and a BM layer is formed between the color filters. As the internal structures of the drive circuit board and the counter substrate are of a typical liquid crystal panel, detailed explanations for the drawing will be avoided.

In the above explanation of the liquid crystal panel 2, the liquid crystal panel 2 is explained as what is prepared by forming color filters in the interior of the counter substrate and capable of displaying a color image. However, the liquid crystal panel used for a liquid crystal display device of the present invention is not limited to a panel for color display, but it also includes what can display in monochrome or multicolors. Further, the color filters are not always formed on the counter substrate, but a substrate structure called ‘CF on array’ also may be employed. In the ‘CF on array’, a color filter (CF) is formed on a drive circuit board called also an array substrate. Further in the above explanation, the common electrode is formed on the counter substrate and a voltage is applied perpendicularly with respect to the liquid crystal layer. An alternative example is a liquid crystal panel of an IPS system, where the common electrode is formed together with the pixel electrode on the drive circuit board and a voltage is applied in the transverse direction with respect to the liquid crystal layer.

The drive circuit board of the liquid crystal panel 2 actually has a larger surface area than that of the counter substrate, and thus it has an exposed part other than the pixel region 10 and not covered with the counter substrate. And on this exposed part, an IC chip 4 formed with a drive circuit for driving the liquid crystal panel 2 is mounted. Though FIG. 1 shows a state where a single IC chip 4 is mounted for convenience in understanding, the liquid crystal panel of a liquid crystal display device of the present invention is not limited thereto, but a plurality of IC chips may be mounted. In FIG. 1, the IC chip 4 is mounted only in the vicinity of one side below of the liquid crystal panel 2 in FIG. 1. In a case where plural IC chips are mounted, IC chips 4 may be arranged in the periphery of the pixel region 10 in the vicinity of two or more sides of the liquid crystal panel 2.

In the IC chip 4, a gate driver, a source driver and the like are formed as drive circuits that drive the liquid crystal panel 2. The gate driver selects sequentially the scanning lines and switches ON/OFF of TFT provided corresponding to the respective pixel electrodes of the pixel region 10, and the source driver inputs an image signal via a corresponding signal line from the TFT that has turned ON to the pixel electrode. Furthermore, power supply voltage generating circuits such as a video data processing circuit that controls the gate driver and the source driver and also a gradient power supply circuit that generates actually a voltage to be applied as an image signal to the pixel electrode are assembled suitably.

Further, in the IC chip 4, a source driver driving voltage generating circuit is formed. This source driver driving voltage generating circuit generates a source driver driving voltage (AVDD) to drive the source driver on the basis of the potential supplied from the exterior of the liquid crystal panel. The explanation below for the present embodiment refers to a case where a power supply voltage generated in the IC chip in the present invention is a source driver power supply voltage.

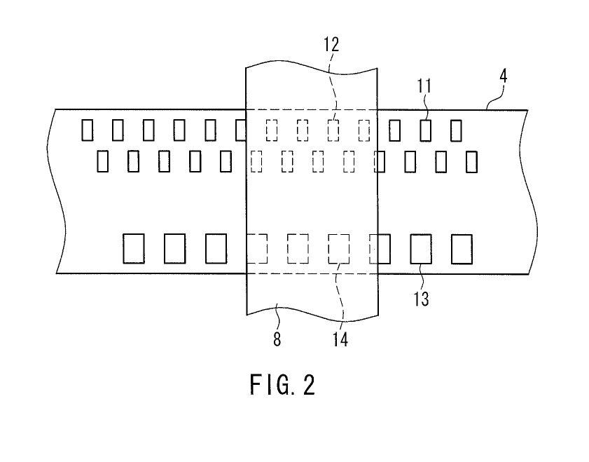

As mentioned below with reference to FIG. 2, the IC chip 4 has a group of output terminals 11 formed closer to the pixel region 10 as the upper area in FIG. 1, and a group of input terminals 13 formed closer to a side of the liquid crystal panel 2 as the lower area in FIG. 1. And the group of output terminals 11 of the IC chip 4 are connected to the scanning lines and the signal lines formed on the pixel region 10, via wirings not shown in the drawing. Further, the group of input terminals 13 of the IC chip 4 are connected to connection terminals of a connection terminal part (not shown) provided in the vicinity of one side of the liquid crystal panel 2, via wirings not shown in the drawing.

The connection terminals of the connection terminal part in the liquid crystal panel 2 are connected to the external circuit board 6 via a flexible printed circuit (FPC) 5 that is a connection wiring board.

A circuit for generating a power supply voltage to operate the drive circuit formed on the IC chip 4 mounted on the liquid crystal panel 2 and various circuits for inputting signals are formed on the external circuit board 6. Furthermore, circuit members such as a capacitor having a comparatively large capacity is mounted, as the members are necessary for generating various kinds of signals and the power supply voltage at the IC chip 4. And in the liquid crystal display device 1 of the present embodiment, a decoupling capacitor 7 that is a stabilizing capacitor element necessary for generating a source driver power supply voltage from the potential inputted into the IC chip 4 is mounted on the external circuit board 6. The decoupling capacitor 7 is connected to the source driver power supply terminal of the IC chip 4, by a power supply stabilizing wiring 8 that connect the drive circuit board of the liquid crystal panel 2 and the external circuit board 6 via the FPC 5.

Further, on the drive circuit board of the liquid crystal panel 2, the source driver power supply terminal of the IC chip 4 is connected directly to the auxiliary capacitor wiring 3 formed on the pixel region 10 via a power supply stabilizing wiring 8. In this manner, a source driver power supply voltage generated at the IC chip 4 by use of the decoupling capacitor 7 formed on the external circuit board 6 is connected directly and applied to the auxiliary capacitor wiring 3 on the drive circuit board of the liquid crystal panel 2 via the power supply stabilizing wiring 8, thereby the source driver power supply voltage can be supplied to the auxiliary capacitor wiring 3 without causing increase in the connection impedance between the terminals.

In a case of connecting the decoupling capacitor 7 on the external circuit board 6 and the auxiliary capacitor wiring 3 on the drive circuit board via the FPC 5 without using a power supply stabilizing wiring, in comparison with the above-mentioned embodiment, the connection will be obtained through two connection terminals, namely, the connection terminals between the external circuit board 6 and the FPC 5 and the connection terminal between the FPC 5 and the drive circuit board, and it causes inevitably increase in the connection impedance that occurs at the connection terminal parts. In addition, since the connection passes through three substrates in total from the connection terminal on the drive circuit board to the connection terminal of the auxiliary capacitor wiring on the drive circuit board, the length of the connection wirings is increased inevitably.

Namely, in the above-mentioned liquid crystal display device 1 of the present embodiment, it is possible to exclude effectively the load fluctuation in the source driver power supply voltage, which is caused by the increase in the connection impedance of the connection terminals and also the increased length of the connection wirings. Since brightness irregularity of the display image is caused by the load fluctuation of the source driver power supply voltage, according to the present embodiment, a liquid crystal display device 1 that suppresses occurrence of such brightness irregularity and provide a high quality of images can be provided.

FIG. 2 is a diagram for showing a connection terminal configuration of the IC chip 4 mounted on a drive circuit board of the liquid crystal display device 1 according to the present embodiment. FIG. 2 shows the IC chip 4 in a state viewed from the mounting surface side when mounted on a drive circuit board of the IC chip 4.

As shown in FIG. 2, on the surface of the IC chip 4 to be mounted on the drive circuit board, a group of output terminals 11 are formed in the vicinity of one end part, while a group of input terminals 13 are formed in the vicinity of the other end part. And, a power supply voltage and/or video signals inputted by the external circuit board 6 via the FPC 5 from the connection terminal part (not shown) that is formed in the vicinity of one side of the drive circuit board of the liquid crystal panel 2 is inputted through the input terminals 13 into the IC chip 4, which is then subjected to a signal processing or the like at the IC chip 4 and thereafter outputted from the output terminals 11 to the scanning lines and/or the signal lines (not shown) on the pixel region 10 via wirings that are formed on the drive circuit board and not shown in the drawing.

As mentioned above, an external decoupling capacitor 7 is required to generate a source driver power supply voltage at the IC chip 4. Since the decoupling capacitor 7 is formed on the external circuit board 6, it is preferred that a terminal 14 to connect the IC chip 4 and the decoupling capacitor 7 is formed in the group of input terminals 13. At this time, since the voltage of the terminal 14 connected to the decoupling capacitor 7 directly makes the source driver power supply voltage, the terminal 14 can be regarded as a source driver power supply voltage terminal 14.

In order to connect this source driver power supply voltage terminal 14 to the auxiliary capacitor wiring 3 in the pixel region 10, in the liquid crystal display device 1 of the present embodiment, on the surface of the IC chip 4 to be mounted on the drive circuit board, one of the group of output terminals 11 formed at a position opposite to the position at which the source driver power supply voltage terminal 14 is formed is made as a dummy terminal 12, thereby the power supply stabilizing wiring 8 is extended directly as a straight line toward the pixel region 10 as the upper area in FIG. 2 so as to connect the source driver power supply voltage terminal 14 to an auxiliary capacitor wiring not shown in FIG. 2.

The power supply stabilizing wiring 8 is extended directly in this manner toward the pixel region 10, so that the source driver power supply voltage terminal 14 and the auxiliary capacitor wiring 3 can be connected to each other in a reduced wiring length. Therefore, the terminal configuration of the IC chip 4 is preferred if it is as shown in FIG. 2. However, the connection terminal arrangement of the IC chip 4 as shown in FIG. 2 is not essential for the present invention. It is possible to form the power supply stabilizing wiring 8 that connects the source driver power supply voltage terminal 14 and the auxiliary capacitor wiring 3 as a wiring other than a straight line. It is also possible to form the source driver power supply voltage terminal 14 at the side of the group of output terminals 11 of the IC chip 4.

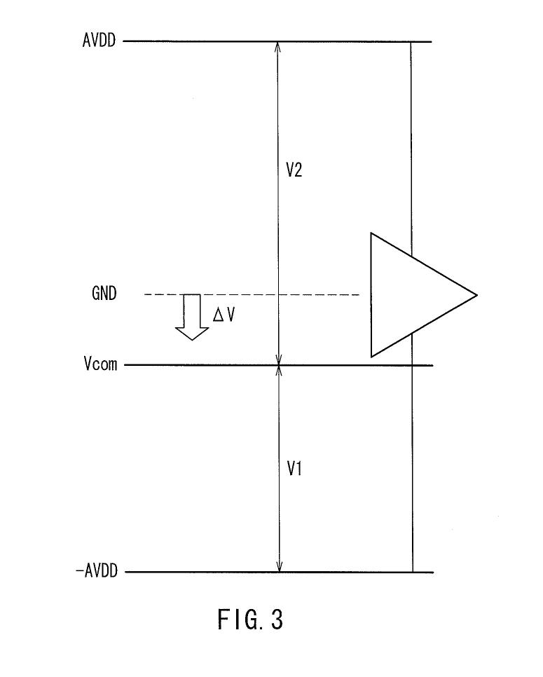

FIG. 3 is a diagram for showing an example of relations of voltages with regard to image display in a liquid crystal display device of the present embodiment.

As exemplified in FIG. 3, in the liquid crystal panel 2 used for the liquid crystal display device 1 of the present embodiment, voltages of two polarities, i.e., positive ADVV and negative −ADVV are used as the source driver power supply voltages. By using these two voltages of positive and negative polarities, any inversion driving such as dot inversion driving, line inversion driving or frame inversion driving is performed to prevent the liquid crystal layer of each pixel from being applied with a voltage of the same polarity constantly thereby shortening the lifetime. At this time, the two voltages, i.e., the positive and negative voltages are generated as the source driver power supply voltage at the IC chip 4 and used. As a result, at the IC chip 4 where a drive circuit of a systematized liquid crystal panel is formed, a process of generating a medium power supply potential can be simplified while a low voltage of the signal processing system and a high voltage for ON/OFF the gate are present in a mixed state.

Specifically, as mentioned above, ADVV can be set as +6 V formed by a technique like a charge pump from 3.3 V of the input potential to the IC chip for example. Similarly, −ADVV can be set as −6 V formed from 3.3 V of the input potential to the IC chip.

At this time, the optimal counter electrode voltage Vcom is the central voltage of ADVV and −ADVV, which is lower than the GND by a predetermined voltage Δ V. The reason is that, since stray capacitance around the pixel electrodes is formed in the pixel region 10 of the liquid crystal panel 2, re-distribution of electric charge occurs via the auxiliary capacitor at the time of gate OFF.

In the liquid crystal display device 1 of the present embodiment, a source driver power supply voltage AVDD is used as the auxiliary capacitor voltage. Therefore, even if the TFT formed in the pixel region 10 would malfunction so that normal voltage could not be applied to the pixel electrodes, it is possible to apply V2 (ADVV−Vcom) in FIG. 3 to the pixel capacitor Clc, which is the potential difference between the potential Vcom of the common electrode and the ADVV as the auxiliary capacitor voltage, by disconnecting the TFT's drain electrode from the pixel capacitor Clc and the auxiliary capacitor Clc by laser processing and also by short-circuiting the auxiliary capacitor Ccs. Since in a typical image display, this potential is a voltage closer to the liquid crystal application voltage to be applied to the pixel electrodes at the time of black display, apparently a bright spot generated due to a TFT defect can be converted into a black spot.

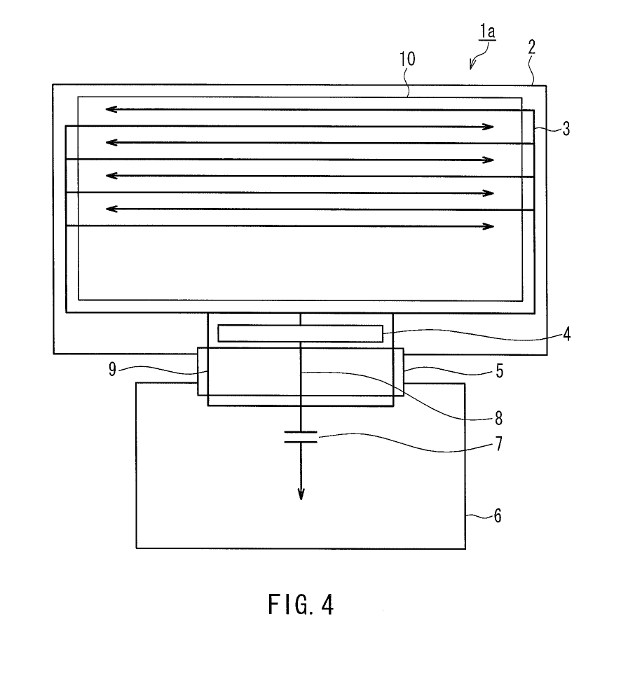

FIG. 4 is a diagram for showing a configuration example of a liquid crystal display device according to another aspect of the present embodiment.

The liquid crystal display device la according to the aspect of the embodiment is different from the liquid crystal display device 1 of the present embodiment as shown in FIG. 1 in that the decoupling capacitor 7 as a stabilizing capacitor formed on the external circuit board 6 and the auxiliary capacitor wiring 3 formed in the pixel region 10 of the liquid crystal panel 2 are connected to each other not only by the power supply stabilizing wiring 8 but also by an auxiliary connection wiring 9 that connects the drive circuit board of the liquid crystal panel 2 from the external circuit board 6 via the FPC 5 as a connection wiring board.

In this manner, the decoupling capacitor 7 and the auxiliary capacitor wiring 3 are connected to each other not only by the power supply stabilizing wiring 8 but by the auxiliary connection wiring 9 formed on the external circuit board 6 and the FPC 5. As a result, connection paths between the source driver power supply voltage terminal 14 of the IC chip 4 and the auxiliary capacitor wiring 3 are increased to further reduce the connection impedance between the source driver power supply voltage terminal 14 and the auxiliary capacitor wiring 3. As a result, the load fluctuation in the source driver power supply voltage is reduced further, and thus, it is possible to avoid effectively noise such as brightness irregularity that degrades the display quality from occurring on the display image.

In the above example referred to in the explanation of the embodiment of the present invention, a flexible printed circuit (FPC) was used as the connection wiring board for connecting a drive circuit board and an external circuit board. However, the means for connecting the drive circuit board and the external circuit board is not limited to the FPC as mentioned above. Any other connection means for connecting circuit boards such as a connector are also included in the concept of the connection wiring board in the present invention.

It is also possible to employ a TCP (Tape Carrier Package) technique where semiconductor elements and circuit elements such as a capacitor for driving a liquid crystal panel is mounted on a FPC. At this time, if a stabilizing capacitor element for generating a source driver power supply voltage at the IC chip is formed on the FPC with reference to the TCP technique, the part of the FPC on which the stabilizing capacitor element is mounted will function also as the external circuit board in the present invention.

The above description of the present embodiment refers to a case of a power supply voltage of a source driver that drives the liquid crystal panel, which is a power supply voltage that is connected to the stabilizing capacitor element mounted on the external substrate and is generated in the IC chip. However, the power supply voltage of the present invention is not limited to this example. Various kinds of power supply voltages such as the logic voltage generated in the IC chip can be connected to an auxiliary capacitor voltage wiring as long as they are capable of achieving the object of the present invention, namely, a bright spot can be converted into a black spot.

Among these various kinds of power supply voltages, a potential should be selected so that the potential difference between the potential of the common electrode and the potential of the auxiliary capacitor is suitable for converting the bright spot into a black spot at the time of connecting to the auxiliary capacitor voltage wiring. For example, in a case where the power supply voltage of the source driver as exemplified above is used and the potential difference becomes greater than the desired potential difference, it is preferable that a logic voltage of a lower potential is used.

Though not shown in FIGS. 1 and 4 or not explained in the corresponding contexts, on the front side and the back side of the liquid crystal panel, a pair of polarizing plates (not shown) are arranged usually in a state oriented in a predetermined direction at the respective polarizing angles differentiated from each other by about 90°. Needless to note, the polarizing plates combined with a liquid crystal layer control the transmission of light so as to display images.

Similarly not shown in the drawing, a backlight to emit a light necessary for displaying images on the liquid crystal panel is arranged at the side closer to the back than the polarizing plates in the liquid crystal panel. The backlight of the liquid crystal display device according to the present invention is either a sidelight type or an edge-light type for example, which is formed of a flat light guide and a light source such as a cold cathode ray tube or a light-emitting diode provided on the side face. Further, a so-called direct type also can be used. A direct type backlight has a light source disposed plainly on the back face of the liquid crystal panel so as to emit light toward the liquid crystal panel, thereby the light from the light source is irradiated on the liquid crystal panel via an optical sheet such as a condensing sheet or a diffusion sheet. Similarly, the light source used for the backlight is not limited to the cold cathode ray tube or the light-emitting diode, but various kinds of light sources such as hot cathode ray tube, an EL emitter or the like can be used.

Similarly, the liquid crystal panel is not limited to a transmission type or semi-transmission type that uses irradiation from the backlight for displaying images, but a reflection type liquid crystal panel can be applied as well. In the reflection type liquid crystal panel, external light that enters via a substrate in the front of the liquid crystal panel is reflected by a reflection electrode formed on a substrate arranged backside, so as to be used for image display. In a case of using such a reflection type liquid crystal panel, the backlight and a polarizing plate to be arranged backside in the liquid crystal panel can be eliminated.

### INDUSTRIAL APPLICABILITY

The present invention provides an industrially available liquid crystal display device, where a drive circuit for driving a liquid crystal panel is mounted as an IC chip on a drive circuit board of the liquid crystal panel. When a normal potential is not applied to pixel electrodes and thus a bright spot is generated, the liquid crystal display device can convert the bright spot into a black spot, thereby preventing degradation in the quality of display images.

1. A liquid crystal display device comprising:
a liquid crystal panel having a drive circuit board on which an IC chip formed with a drive circuit for driving the liquid crystal panel is mounted, a counter substrate arranged opposite to the drive circuit board, and a liquid crystal layer sandwiched between the drive circuit board and the counter substrate;
an external circuit board on which a stabilizing capacitor element for generating a power supply voltage in the IC chip is mounted; and
a connection wiring board for connecting the drive circuit board and the external circuit board,
wherein an auxiliary capacitor wiring for applying an auxiliary capacitor voltage to an auxiliary capacitor arranged in a pixel region of the drive circuit board and a power supply voltage terminal for supplying the power supply voltage of the IC chip are connected directly to each other on the circuit board.

2. The liquid crystal display device according to claim 1, wherein the connection between the power supply voltage terminal formed at an input terminal side of the IC chip and the auxiliary capacitor wiring is provided via a dummy terminal formed at an output terminal side of the IC chip.

3. The liquid crystal display device according to claim 1, wherein the stabilizing capacitor element of the external circuit board and the auxiliary capacitor wiring are connected to each other via an auxiliary connection wiring formed on the external circuit board and on the connection circuit board.

4. The liquid crystal display device according to claim 1, wherein the power supply voltage generated in the IC chip is a source driver power supply voltage that drives the liquid crystal panel.
